(19) United States
(12) Patent Application Publication
(10) Pub. No.: US 2026/0251243 A1
(43) Pub. Date: Aug. 27, 2026

(54) IMPROVED TUBULAR ASSEMBLY INTENDED FOR BEING CONNECTED TO A SECOND TUBE

(71) Applicant: PERMASWAGE, LES CLAYES-SOUS-BOIS (FR)

(72) Inventors: Mohamad KARDOFAKI, VÉLIZY VILLACOUBLAY (FR); Stéphane HÉRAUD, PARIS (FR); Faycel HALILA, CLAMART (FR)

(21) Appl. No.: 18/992,357

(22) PCT Filed: Jul. 7, 2023
(86) PCT No.: PCT/EP2023/068937

§ 371 Date: Feb. 12, 2025

(30) Foreign Application Priority Data
Jul. 8, 2022 (FR) FR2207060
Feb. 7, 2023 (FR) FR2301149

(51) Int. Cl. F16L 19/02

(52) U.S. Cl. CPC F16L 19/0212; F16L 2201/10

(57) ABSTRACT

A tubular assembly includes a rotationally symmetrical tube including at least a first axial abutment, a second axial abutment intended to abut with a second tube to be connected, and a sealing wall including an internal surface formed by a recess enabling the sealing wall to be elastically deformed by compression having at least one axial component on an external sealed deformation surface radially opposite the internal surface. The assembly further includes an attachment member mounted and axially movable around the tube between a free position and an abutment position, including an axial attachment system for attaching to the second tube and an axial abutment abutting with the first axial abutment of the tube in the abutment position.

### TECHNICAL FIELD OF THE INVENTION

The technical field of the invention is that of tube joints.

This invention relates to an assembly comprising a tube and an axial fastening member for sealingly fastening the tube to another tube.

### TECHNOLOGICAL BACKGROUND OF THE INVENTION

Metal tubes for transporting fluids from a zone to a second zone are known. It is often necessary to join different tubes together. One of the problems is to ensure sealing between each tube joint.

One solution is a welded joint, but for a number of reasons, such as the risk of fire during welding or even an access behind the tubes, this type of joint is not possible in different applications. Dismountable joints between two tubes are known in this case. Both tubes can be manufactured by different suppliers, thus requiring joints that adapt to the manufacturing restrictions of the different manufacturers.

FIG. 1 represents a first tube assembly 1 joined to a second tube 2 according to a proposed implementation by the applicant.

The tube assembly 1 comprises a tube 10 and a nut 12 comprising a tapping for screwed attachment to the thread of the second tube 2. The first tube 10 comprises an inner surface surrounding a volume in which the fluid circulates up to an open end. The inner surface is a regular cylindrical surface (same diameter) to reduce head losses.

The first tube 10 comprises a joint portion 100 comprising part of the cylindrical inner surface up to the open end and a conical outer surface. The second tube comprises, at its open end, a conical inner surface corresponding to the conical outer surface of the first tube, each forming a sealing and abutment contact surface.

The first tube 10 further comprises an abutment 112 against a snap ring 121 inserted into a bore of the nut to abut against the abutment 112.

When the nut 12 is screwed onto the second tube 2, the snap ring 121 comes into abutment against the abutment 112 on the first tube 10 and moves the sealing and abutment contact surfaces of both tubes axially closer together. Clamping the nut with the second tube 2 causes a restriction of the conical outer surface of the joint part 100 with the conical inner surface of the second tube. However, as both sealing and abutment contact surfaces may have different dimensional restrictions, caused by the dimensional tolerances of the tubes, snap ring and nut which are linked to manufacture, and as this joint is made blind, it is necessary to “run-in”, i.e. a step to measure and check the joint to then ensure the blind joint of both tubes. Indeed, in practice, before mounting to a machine, the operator can clamp the nut on the second tube a first time, measure the clamping torque, carry out a leak test between both tubes, loosen the nut and disconnect both tubes, and then, when both tubes are joined together on the machine, performing joining by applying a clamping torque corresponding to the clamping torque performed. Furthermore, this double step enables the coupling to be run in and checks that both tubes have not undergone any plastic deformation as a result of this clamping.

This double step performed by the operator is time-consuming and therefore costly. Furthermore, during multiple joining operations, the clamping torque can change due to wear between the thread and tapping or between both conical surfaces.

There is therefore a need for a dismountable joint that ensures proper sealing between both tubes without the need for the user to perform both operations without modifying the second tube.

### SUMMARY OF THE INVENTION

The invention offers a solution to the problems discussed previously, by providing a dismountable joint for two tubes, which ensures a level of sealing by metal/lubricant/metal contact and by an axial abutment between both tubes.

One aspect of the invention relates to claim 1

By virtue of the invention, the sealing wall of revolution has a sealing role and the radial surface in abutment against the first abutment makes it possible to determine the end of travel. Indeed, the operator can screw the nut using a torque spanner and when both abutments come into contact (second abutment against an abutment on the corresponding second tube).

The sealing wall of revolution is indeed adapted to deform elastically when joining with the second tube by having the outer sealed deformation surface bearing against a tilted surface of the second tube to be joined providing sealing therebetween. The nut in the abutment position on the first tube, when screwed onto the second tube, moves both tubes towards each other, so that the tilted surface of the second tube bears and slides (by friction which can be reduced by virtue of a lubricant, for example dry) on the outer sealed deformation surface of the tilted part, which elastically deforms the sealing wall of revolution until the second surface forming the second axial abutment on the first tube is in abutment against an abutment on the second tube to be joined. In other words, the outer sealed deformation surface is for abutting and sliding against a tilted surface (between radial and axial, for example at X° relative to the axis of the tubes such that the angle is measured on the side of the second tube) of a sealing wall of the second tube to be joined in order to elastically deform the sealing wall of revolution and thus provide sealing against this sealing wall of the second tube.

When the fastening member is first fastened to the second tube, the sealing wall will deform mainly elastically and may deform locally plastically, but during the different dismounting and mounting operations, the sealing wall will only elastically deform.

Further to the characteristics just discussed in the preceding paragraph, the tubular assembly according to one aspect of the invention may have one or more complementary characteristics from among those in the following paragraphs, considered individually or according to any technically possible combination.

According to one embodiment, the first tube comprises a main tubular zone comprising a regular thickness between an inner and outer surface, the connection zone comprising a junction end extending from the main tubular zone having an inner or outer diameter different from that of the main tubular zone and wherein the connection zone comprises an inner volume of the tube from the junction end to the first end forming a free edge surrounding the axial opening, the joining wall comprising an inner surface surrounding a first part of the inner volume and wherein the sealing wall surrounds a second part of the inner volume extending from the first part of the inner volume to the axial opening.

According to one example of this embodiment, the inner surface of the joining wall comprises different diameters, of which a part of the inner surface between two axial ends has a diameter forming the smallest volume of the first part of the inner volume, the first axial abutment being axially located between the ends of the part of the inner surface.

According to another example, the inner surface of the joining wall comprises a constant diameter, forming the first part of the inner cylindrical-shaped volume.

According to one embodiment, the joining wall comprises an inner part having a first diameter and a restriction zone between the inner part and the sealing wall, the restriction zone having the smallest diameter of the connection zone.

According to one embodiment, the joining wall comprises a groove extending from the first surface of the collar to another abutment surface, the axial abutment of the fastening member being movable in the groove between the first axial abutment, and the other abutment surface delimiting the groove.

According to one example, the other abutment surface delimiting the groove and the first surface of the collar have a shape corresponding to the shape of the axial abutment of the fastening member. This avoids deforming the abutment of the fastening member. According to one exemplary embodiment, the end of the collar at the first surface forming a first axial abutment is a fillet.

According to one embodiment, the collar comprises a groove dividing the collar into a first and a second part, the first part comprising the first axial abutment comprising an axially measured thickness:
lower than that of the second portion comprising the second axial abutment,
greater than the thickness of the sealing wall measured between the inner surface and the outer surface of the sealing deformation.

According to one embodiment, the axial abutment on the fastening member is a snap ring.

According to one example of this embodiment, the fastening member comprises a snap ring insertion port passing through the fastening member from an outer surface to an inner surface facing the tube, the insertion port comprising a section corresponding to the snap ring at an inner surface surrounding the tube.

According to one embodiment, the fastening member is a nut and the fastening means is a tapping to be screwed to a thread of the second tube.

According to one alternative, the fastening member comprises a thread to be screwed into a nut of the second tube.

According to one embodiment, the sealing wall further comprises a cylindrical part of revolution extending from the tilted part to the second axial abutment of the collar. This allows greater flexibility of the tilted part to elastically deform.

According to one alternative of this embodiment, the sealing wall only comprises the tilted part directly extending from the second axial abutment of the collar.

According to one embodiment, the part of the inner surface forming part of the tilted part of the sealing wall is curved. This facilitates elastic deformation of this tilted part when it comes into contact with the second tube.

According to one embodiment, the outer sealed deformation surface is curved. This means that there is less friction due to contact with the second tube during elastic deformation of the tilted part.

According to another embodiment, the tilted part of the sealing wall has the shape of a conical spring washer.

According to one example of this embodiment, the tilted part of the sealing wall has the shape of a conical spring washer. For example, the part of the inner surface forming part of the tilted part of the sealing wall is also frustoconical.

According to one embodiment, the thickness of the sealing wall between the inner surface and the outer sealed deformation surface varies by less than 10%. For example, the part of the inner surface forming part of the tilted part of the sealing wall is concentric with the outer sealed deformation surface (in the case of a curved surface, they are therefore parallel).

According to one embodiment, each element is metallic, for example steel, stainless steel, aluminium alloy or titanium alloy. For example, the tube is a Stainless Steel type steel, the fastening means comprises the stainless steel axial fastening means and the abutment which is of stainless steel.

According to one embodiment, the outer sealed deformation surface is tilted relative to an axis of the tube at a mean angle of between 1° and 45° inclusive. An mean angle in the case of a curved outer sealing deformation is a mean of the angles between the tangents of a section of the surface and the axis X. The mean angle in the case of a frustoconical outer sealing surface is the angle between the straight line of a section of the surface and the axis X.

According to one example of this embodiment, the part of the inner surface forming part of the tilted part of the sealing wall is tilted relative to an axis of the tube at a mean angle of between 1° and 45° inclusive.

According to another embodiment, the outer sealed deformation surface is tilted relative to an axis of the tube at a mean angle of between 45° and 90°, the counterbore forming a recess delimiting the sealing wall forming its inner surface.

According to one example of this other embodiment, the outer sealed deformation surface extends from the second surface forming the second axial abutment of the collar.

According to one example of this other embodiment, the part of the inner surface forming part of the tilted part of the sealing wall is tilted relative to an axis of the tube at a mean angle of between 45° and 90°.

According to one embodiment, the collar is formed such that the second surface is at the axial end of the tube. In this example, the sealing wall comprises only the tilted part directly extending from the second surface.

According to another embodiment, the sealing wall further comprises a cylindrical part of revolution extending from the tilted part to the second surface of the collar.

According to one embodiment, the joining wall comprises an outer surface comprising, between the first surface forming a first axial abutment, and an end of the joining wall axially opposite to the sealing wall, a visual indicator corresponding to a zone at least partially covered with the fastening member in the free position and at least partially uncovered in the abutment position, when the fastening member is coupled to a second tube. Thus this indicator shows the operator whether the first tube is properly joined to the second tube.

According to one example of the mode comprising a visual indicator, the visual indicator is a marking indicating that clamping is not complete.

According to one example, the visual indicator is only fully visible in the abutment position.

According to another example, the visual indicator is partially uncovered from the free position.

According to one example the fastening member comprises an axial end opposite to the axial fastening means, the fastening member comprising notches at this axial end. This enables the operator to see when he/she gets closer to the abutment position to be reached.

According to one example, the outer surface extends from the other abutment surface to the end of the joining wall.

According to one embodiment, the collar further comprises a groove dividing the collar into a first portion comprising the first abutment surface and a second sealing and abutment wall, the second sealing and abutment wall comprising an outer sealed deformation surface extending from the second surface forming a second axial abutment, the groove allowing the second sealing wall to be elastically deformed by compression having at least one axial component on the outer sealed deformation surface.

According to one example of this embodiment, the second collar sealing wall further comprises:
a radial inner surface defining the volume of the counterbore, extending between a first radial end and a second radial end joining a surface of the bottom of the counterbore, the first radial end being opposite to the second radial end,
a radial outer surface joining a first radial end of the outer sealed deformation surface and the first radial end of the radial inner surface,
an inner end axially extending into the collar between the second radial end of the radial inner surface and a second radial end of the outer sealed deformation surface joining the second surface forming a second axial abutment.

According to one example of this embodiment, the outer sealed deformation surface surrounds part of the sealing wall of revolution. According to one implementation of this example, the outer sealed deformation surface of the collar is tilted relative to the second surface forming a second axial abutment. According to another implementation of this example, the sealing wall comprises an extra thickness causing the outer sealed deformation surface to protrude from the second surface forming a second axial abutment.

According to one example of this embodiment, the outer sealed deformation surface is adapted to be elastically deformed by a surface of the second tube in contact with this outer sealed deformation surface until this surface of the second tube is in abutment against the second surface forming the second axial abutment.

The invention also relates to a joined assembly comprising:
an assembly according to the preceding aspect with or without one or more of the different characteristics of the preceding paragraphs,
the second tube comprising:
   a sealing surface tilted relative to the axis in contact with and bearing against the outer sealed deformation surface elastically deforming the sealing wall and
   an axial abutment in axial abutment with the second axial abutment of the joining wall and wherein the axial fastening means is fastened to the complementary fastening means,
a lubricant layer between the outer sealed deformation surface and the tilted sealing surface.

According to one embodiment of this joined assembly, the lubricant layer is a dry lubricant deposited onto the outer sealed deformation surface.

According to one embodiment of this joined assembly, the tilted sealing surface of the second tube comprises a first free end and a second end opposite to the free end extending from the radial surface forming the axial abutment of the joining wall, wherein the tilted sealing surface is frustoconical having a diameter at the first free end greater than the largest diameter of the outer sealed deformation surface and a diameter at the second end lower than the largest diameter of the outer sealed deformation surface.

According to one embodiment of this joined assembly, elastic deformation of the sealing wall by the tilted sealing surface of the second tube forces the outer sealed deformation surface of the first tube to press against the tilted sealing surface of the second tube.

Another aspect of the invention relates to a method for marking a tubular assembly according to the aspect of the preceding invention (claim 14).

According to one exemplary embodiment of this method, the step of making a visual indicator on the tube is a laser made marking, for example all around the tube on an axially delimited zone.

Another invention not claimed relates to a tubular assembly to be joined to a second tube characterised in that the assembly comprises:
A tube of revolution about an axis comprising a connection zone comprising:
   a joining wall of revolution comprising at least one collar comprising:
   a first surface forming a first axial abutment, and
   a second surface opposite to the first surface, forming a second axial abutment for abutting against the second tube,
   an outer surface comprising, between the first surface forming a first axial abutment and an end of the joining wall axially opposite to the second axial abutment, a visual indicator,
   a sealing wall of revolution extending from the joining wall, the sealing wall comprising an outer sealed deformation surface having a diameter progressively and continuously increasing from a first free end surrounding an opening in the tube to a second end opposite to the first end,
an fastening member mounted and axially movable about the connection zone between a free position in which the visual indicator is at least partially covered with the fastening member and an abutment position in which the visual indicator is visible, comprising:
   an axial fastening means to be fastened to a complementary fastening means on the second tube to be joined, and
   an axial abutment in abutment with the first axial abutment of the tube collar in the abutment position.

This invention makes it possible to indicate to a user that the first tube is in abutment with the second tube when joining both tubes via the attachment member covering both axial abutments. The visual indicator can be made by the previously described method.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of an axial cross-section of a tubular assembly according to prior art.

FIG. 2 shows an axial cross-section of a tubular assembly according to one example of a first embodiment in a free position.

FIG. 3 shows an enlargement of FIG. 2.

FIG. 4 shows an axial cross-section of a joined assembly comprising the tubular assembly represented in FIG. 2, in a free position.

FIG. 5 shows an axial cross-section of an alternative of the joined assembly in an abutment position.

FIG. 6 shows an axial cross-section of a marking joined assembly (M) in an abutment position, according to a second example of the first embodiment.

FIG. 7 shows an axial cross-section of a joined assembly in an abutment position comprising a tubular assembly according to a third example of the first embodiment.

FIG. 8a shows an axial cross-section of an example of part of a joined assembly comprising a tubular assembly according to the first embodiment in a first position showing contact of a tilted part of the first tube with a tilted sealing surface of the second tube.

FIG. 8b shows a representation of an axial cross-section of the part of the joined assembly of FIG. 7a showing deformation of the tilted part of the first tube by the tilted sealing surface of the second tube.

FIG. 8c shows an axial cross-section of the part of the joined assembly of FIG. 7a in an abutment position showing deformation of the tilted part of the first tube by the tilted sealing surface of the second tube.

FIG. 9a shows an axial cross-section of an example of part of a joined assembly comprising a tube assembly according to a second example embodiment in a position prior to contact of a tilted part with a tilted sealing surface of the second tube.

FIG. 9b shows an axial cross-section of the part of the joined assembly in an abutment position.

FIG. 10 shows the marking joined assembly (M) in a free position comprising the tubular assembly according to a first example of the first embodiment.

FIG. 11 shows a representation of the joined assembly of FIG. 10 in an abutment position.

FIG. 12 shows a representation of different chains of dimensions on an axial cross-section of the first example of the tubular assembly according to the first embodiment in the abutment position.

FIG. 13a shows an axial cross-section of an example of part of a joined assembly comprising a tubular assembly according to a third embodiment in an abutment position.

FIG. 13b shows an enlargement of the cross-section of FIG. 13a.

FIG. 14a shows an axial cross-section of an example of part of a joined assembly comprising a tubular assembly according to one example of a fourth embodiment in an abutment position.

FIG. 14b shows a schematic diagram of a framed zone of the cross-section of FIG. 14a.

FIG. 14C schematically shows an example of tube of the tube assembly according to the fourth embodiment.

### DETAILED DESCRIPTION

The figures are set forth by way of indicating and in no way limiting purposes of the invention.

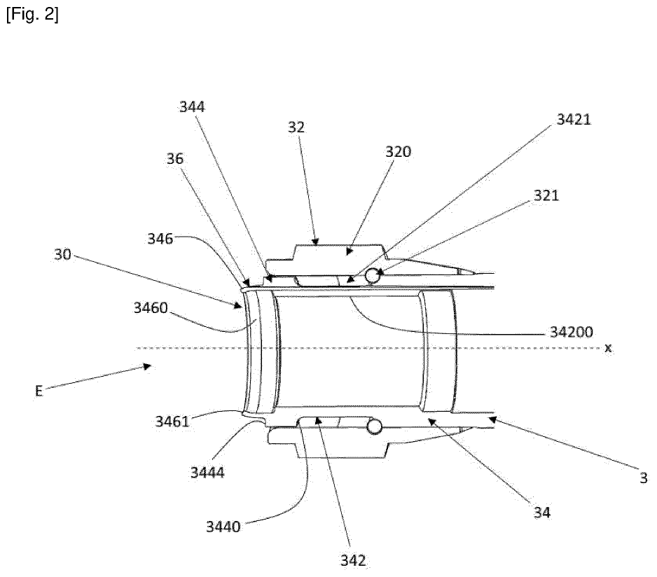

FIG. 2 shows a schematic representation of an axial cross-section of a tubular assembly E according to a first example of a first mode of the invention.

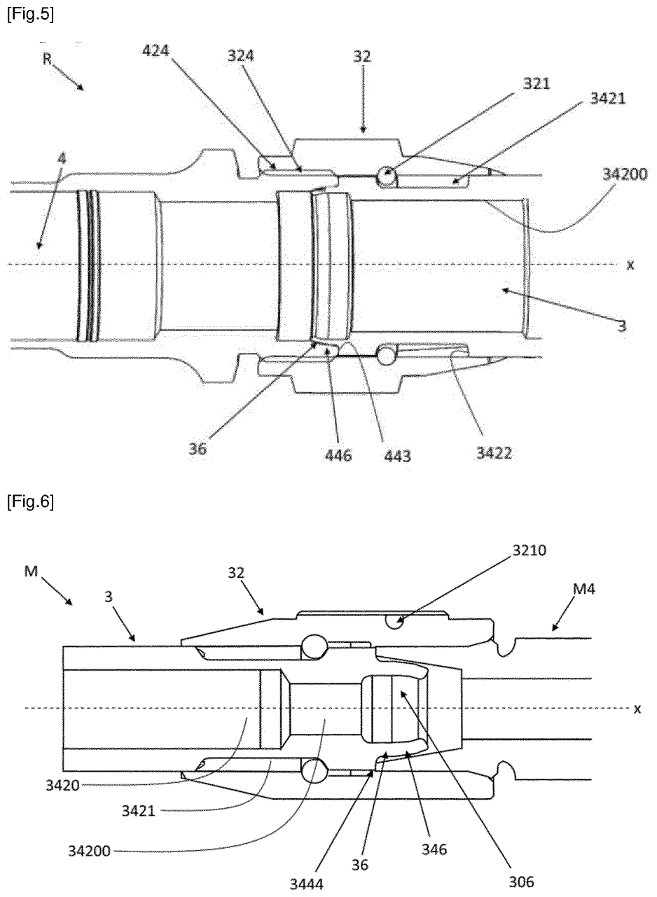

The tubular assembly E is to be joined to a second tube 4 represented in an axial cross-section in a joined assembly R in FIG. 4. In other words, the joined assembly R comprises the tubular assembly E and the tube 4 joined together. FIG. 5 represents a joined assembly R comprising a tubular assembly E according to one alternative of the first example of the first embodiment. FIG. 6 represents a joined assembly R different from that of FIG. 4.

Assembly E comprises a fastening member 32 and a tube 3 of revolution about an axis X. The tube 3 comprises a connection zone 34 and a main tubular zone. The tube 3 and/or the fastening member 32 are each made of metal, for example steel, stainless steel, aluminium alloy or titanium alloy. For example, tube 3 and fastening member 32 are each of a stainless type steel.

The main tubular zone comprises a regular thickness between an inner and outer surface, herein they are cylindrical. The delimitation of the connection zone 34 and the main tubular zone is formed by a junction end of the connection zone 34 extending from the main tubular zone and having an inner or outer diameter different from that of the main tubular zone. The connection zone 34 comprises an inner volume of the tube 3 from the junction end to an opening 30 formed by a first end 3461 forming a free edge surrounding the axial opening 30.

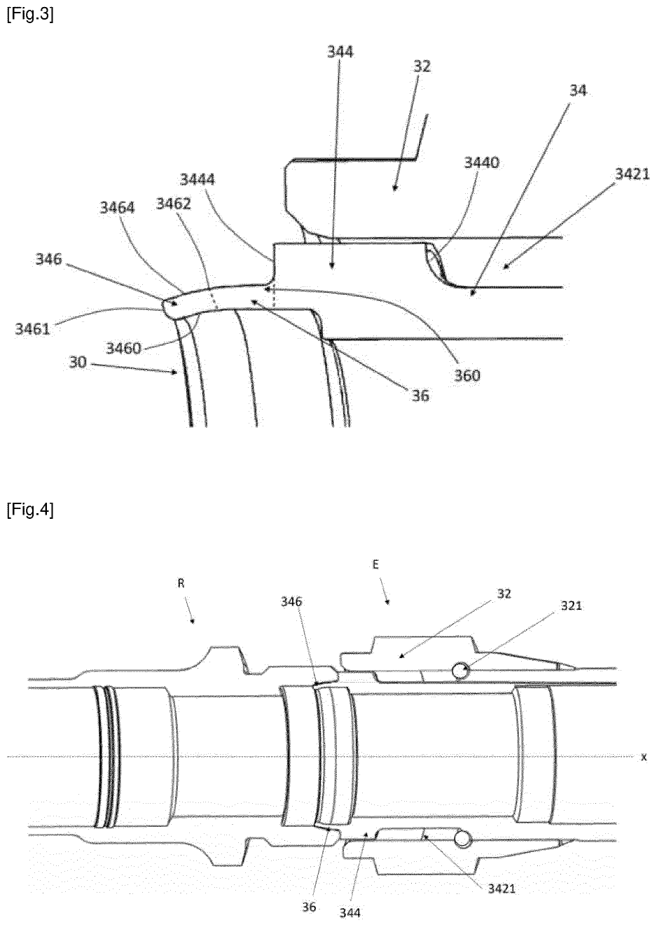

FIG. 3 shows an enlargement of FIG. 2 at this connection zone 34. The fastening member 32 is mounted and is axially movable around the connection zone 34 between a free position and an abutment position. The fastening member 32 thus comprises an axial fastening means 324 fastened to a complementary fastening means 424 of the tube 4 enabling them to be fastened together. In this example, the fastening member 32 is herein a nut, the fastening means 324 of which is a tapping and the complementary fastening means 424 of the tube 4 is a thread to be screwed together.

The connection zone 34 comprises a joining wall 342 of revolution comprising at least one collar 344. The collar 344 comprises a first surface forming a first axial abutment 3440 and a second surface forming a second axial abutment 3444.

The tube 4 also comprises an axial abutment 404 abutting against the second axial abutment 3444 when in the abutment position (and therefore potentially joined to the tube 3).

The fastening member 32 comprises an axial abutment 321 in abutment against the first axial abutment 3440 of the collar 344 of the tube 3 in the abutment position.

Thus, to perform the fastening, herein by screwing, the fastening member 32 moves along an axis X of revolution towards the tube 4, until the axial abutment 321 is in abutment against the first axial abutment 3440 of the collar 344. During fastening, herein during screwing, the second tube 4 moves closer to the first tube until it is in contact with the second axial abutment 3444 of the collar 344.

In this first embodiment, the second tube 4 comprises an axial abutment 443, herein at the axial end of the complementary fastening means 424 of the tube 4.

The joining wall 342 comprises a groove 3421 extending from the first surface 3440 of the collar 344 to another abutment surface 3422 (referenced in FIG. 5 representing an alternative to the first example represented in FIGS. 2 to 4). The axial abutment 321 of the fastening member 32 is movable in the groove 3421 between the first axial abutment 3440, and the other abutment surface 3422 delimiting the groove 3421. The assembly E represented in FIG. 5 is an alternative to that of FIG. 4 in that the other abutment surface 3422 delimiting the groove 3421 is a radial surface whereas in the first example, as represented in FIGS. 2 and 4, the other abutment surface 3422 delimiting the groove 3421 has a shape corresponding to the shape of the axial abutment 321 of the fastening member 32. In these two examples, the first surface of the collar 344 (forming an abutment) has a shape corresponding to the shape of the axial abutment 321.

In this embodiment, the axial abutment 321 of the fastening member 32 is a snap ring. The fastening member 32 comprises an insertion port 3210, visible in cross-section in FIG. 6 as well as in FIGS. 10 and 11 representing an external view of the first example of the first embodiment in a free position and an abutment position respectively. The insertion port 3210 has a helical shape, the cross-section of which corresponds to that of the snap ring 321, passing through the fastening member 32 from an outer surface to an inner surface facing the tube 3. The insertion port 3210 allows the snap ring to be inserted (by plastic or elastic deformation) into the groove by surrounding the tube 3. Thus, to form the assembly E, the fastening member 32 without the snap ring forming the fastening member 32 is fitted onto the connection zone 34 until the inner outlet of the insertion port 3210 faces the groove 3421, the snap ring is then inserted into the insertion port 3210 (via its outer inlet) which deforms and comes out of the inner outlet by deforming in the groove 3421 until it forms the axial abutment 321.

The tube 3 further comprises a sealing wall 36 of revolution extending from the joining wall 342 opposite to the first axial abutment 3440.

The joining wall 342 comprises an inner surface 3420 surrounding a first part of the inner volume of the connection zone 34 and the sealing wall 36 surrounds a second part of the inner volume extending from the first part of the inner volume to the axial opening 30.

The sealing wall 36 comprises a tilted part 346 relative to the axis X of revolution of the tube 3, i.e. its inner and outer surfaces are neither parallel nor perpendicular to the axis X of revolution. The tilted part 346 comprises the first end 3461 of the tube 3.

The tilted part 346 further comprises a second end 3462 axially opposite to the first end 3461. In other words, the tilted part 346 is delimited in the axial direction between its two ends 3462, 3461. Beyond the second end 3462, either the second end 3462 is also that of the sealing wall 36 (as in the second embodiment explained below, or the sealing wall 36 comprises a non-tilted part, herein in this first embodiment a cylindrical part 360 of revolution (having its inner and outer surfaces parallel to the axis X of revolution) extending from the second end 3462 to the second axial abutment 3444 of the collar 344.

The tilted part 346 further comprises an outer sealed deformation surface 3464 having a diameter progressively and continuously increasing from the first free end 3461 to the second end 3462.

The sealing wall 36 comprises an inner surface 3460 radially opposite to the outer sealed deformation surface 3464 formed by a counterbore 3060 enabling the sealing wall 36 to be elastically deformed by compression having at least one axial component on the outer sealed deformation surface 3464.

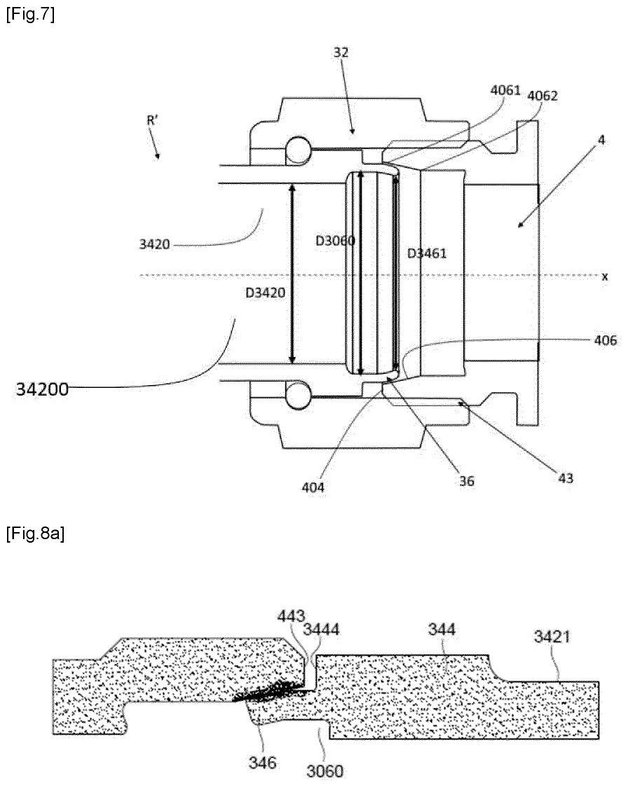

FIG. 7 represents a cross-section of a joined assembly R′ comprising an assembly E according to a third example of this first embodiment, wherein differences in the inner diameters of the inner surface 3420 of the joining wall 342 are referenced. A part 34200 of the inner surface 3420 has a constant diameter D3420 forming the smallest volume of the first portion of the inner volume. The part 34200 is delimited between an inner chamfer and the counterbore 3060. The first axial abutment 3440 is axially located at the part 34200 of the inner surface 3420, that is between the inner chamfer and the counterbore 3060. Furthermore, the example represented in FIG. 7 is different in that the fastening member 32 is axially shorter and does not include any marking explained below.

In this first embodiment, at least prior to joining, the inner surface 3460 formed by the counterbore comprises a larger diameter D3060 at the second axial abutment 3444 of the collar 344 than the diameter D3461 of the inner surface 3460 at the opening 30. The constant diameter D3420 of part 34200 is smaller D3060, D3461 than those of the counterbore.

The second tube 4 comprises a tilted sealing surface 406 (referenced in FIG. 7) relative to the axis X which, when the tube 4 is joined to the tube 3, contacts and bears against the outer sealed deformation surface 3464 by elastically deforming the sealing wall 36. In other words, upon joining, initially the outer sealed deformation surface 3464 comes into contact with the tilted sealing surface 406 of the tube 4, and upon fastening, by moving the tube 4 towards the tube 3 via the fastening member 32, the sealing wall 36 deforms until the axial abutment 404 is in axial abutment with the second axial abutment 3444 of the joining wall 342.

In the first example represented in FIG. 4 and its alternative in FIG. 5, as well as in the third example in FIG. 7, the tilted sealing surface 406 of the tube 4 is formed by a countersink and extends from an inner intermediate cylindrical surface formed by a counterbore. The inner intermediate cylindrical surface comprises a larger diameter than the main inner surface extending from this inner intermediate cylindrical surface of the tube 4. In the second example of FIG. 6, the tilted sealing surface 406 of tube 4 extends from a free end to an inner end adjoining the main inner surface via an inner shoulder (the inner end has a diameter having a value between that of the diameter of the main inner surface and that of the diameter of the free end).

Furthermore, according to one example, the outer sealed deformation surface 3464 is curved by being convex or frustoconical allowing it to deform by limiting friction when it comes into contact with the tilted sealing surface 406. According to one option, the part of the inner surface 3460 forming part of the tilted part 346 of the sealing wall 36 is curved by being concave or is frustoconical as in the example represented. The tilted part of the sealing wall can thus be shaped like a conical spring washer.

The thickness of the sealing wall 36 between the inner surface 3460 and the outer sealed deformation surface 3464 varies by less than 10% and is preferably constant. In particular the part of the inner surface 3460 forming part of the tilted part 346 of the sealing wall 36 is concentric with the outer sealed deformation surface 3464.

The tilted sealing surface 406 of the second tube 4 comprises a first free end 4061 and a second inner end 4062 axially opposite to the first free end 4061. The first free end 4061 extends from the radial surface forming the axial abutment 404. The tilted sealing surface 406 is frustoconical having a diameter at the first free end 4061 greater than the largest diameter of the outer sealed deformation surface 3464 and a diameter at the second end 4062 lower than the largest diameter of the outer sealed deformation surface 3464.

In this first embodiment, the outer sealed deformation surface 3464 is tilted relative to the axis X of revolution of the tube 3 at a mean angle between 1° and 45° inclusive, herein for example 15° before deformation. The part of the inner surface 3460 forming part of the tilted part 346 of the sealing wall 36 is tilted relative to the axis of revolution of the tube 3 at a mean angle of between 1° and 45° inclusive. Herein as this part of the inner surface 3460 is concentric with the outer sealed deformation surface 3464, the angle is also 15°.

The outer sealed deformation surface 3464 allows sealing contact to be made with the tilted sealing surface 406 of the tube by forces exerted on each other by elastic deformation when the axial abutment 404 is in axial abutment with the second axial abutment 3444 of the joining wall 342. The joined assembly comprises a lubricant layer between the outer sealed deformation surface 3464 and the tilted sealing surface 406 in order to reduce friction between these two surfaces during fastening and therefore deformation.

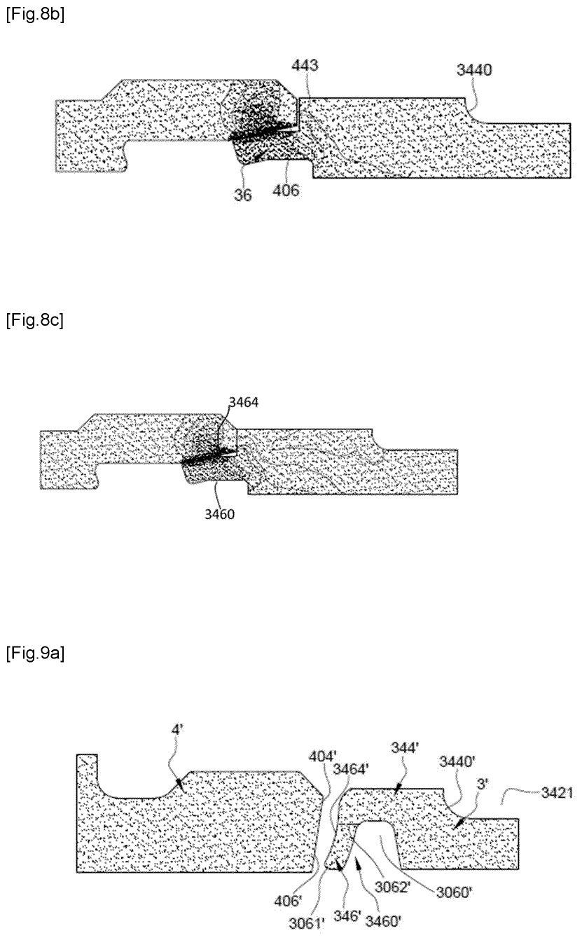

In FIGS. 8a to 8c, differences in stresses in the sealing wall 34 can be seen as a function of the deformation of the sealing wall 34 as the axial abutment 443 of the second tube 4 gets closer to the second axial abutment 3444 of the tube 3. In FIG. 8a, the outer sealed deformation surface 3464 is brought into contact with the tilted sealing surface 406, in FIG. 8b the tube 3 has moved closer to the tube 4 in an intermediate position (by means of the fastening member 32 not represented which screws onto the thread of the tube 4) by deforming the sealing wall 34. In FIG. 8c, the tube 3 can be seen joined to the second tube 4 with the axial abutment 443 of the second tube 4 in abutment with the second axial abutment 3444 of tube 3. In this position, visible stresses exerted by the elastic deformation in the sealing wall 34 allow sealing between the outer sealed deformation surface 3464 and the tilted sealing surface 406.

According to a second embodiment, assembly E and assembly R are different from the first embodiment in that the sealing wall 36′ of tube 3 is different as well as the tilted sealing surface 406′ of the second tube 4′.

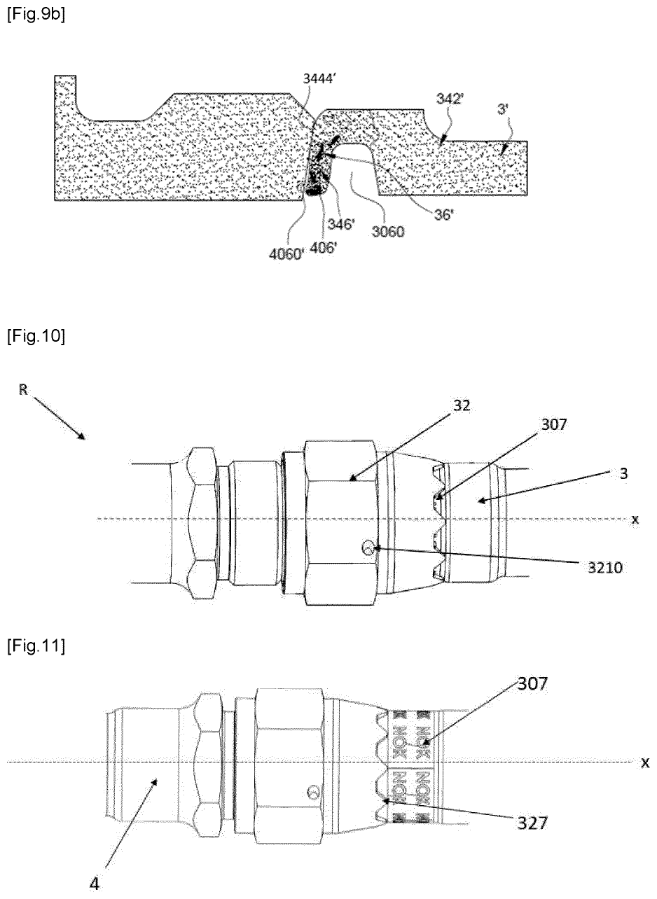

FIGS. 9a and 9b represent a cross-section of part of the tube 3 and second tube 4 of the assembly R at the sealing wall 36′ and tilted sealing surface 406′ in non-joined and joined position respectively.

In this second embodiment, the sealing wall 36′ comprises only the tilted part 346′ which directly extends as an extension of the second axial abutment 3444′ of the collar 344′ and the outer sealed deformation surface 3464′ is tilted relative to the axis X of revolution of the tube 3′ at a mean angle of between 45° and 90°. Herein the tilted part 346′ comprises only the outer sealed deformation surface 3464′ which extends as an extension of the second surface forming the second axial abutment 3444′. The counterbore in this second embodiment forms a recess 3060′ delimiting the sealing wall 346′ forming its inner surface 3460′, part of which forming part of the sealing wall 36′ is tilted relative to the axis X of revolution of the tube 3′, also having a mean angle between 45° and 90°. Preferably as in the first embodiment, this part of the inner surface 3460 forming part of the sealing wall 36 is parallel to the outer sealed deformation surface 3464′ and each are in this case curved (concave for the outer sealed deformation surface 3464′ and convex for this part of the inner surface 3460). The collar 344′ of the joining wall 342′ of revolution is therefore formed by the groove 3421 (forming the first axial abutment) and the curved part of the outer sealed deformation surface 3464′. The advantage of this second embodiment is that the connection zone is axially more compact.

The tilted sealing surface 406′ of the second tube 4′ extends as an extension of the axial abutment 404′ to a first free inner end 4060′. The tilted sealing surface 406 and the axial abutment 404′ are a frustoconical surface having an outer diameter at the outer end of the axial abutment 404′ greater than the largest diameter of the outer sealed deformation surface 3464′ and an inner diameter at the first free inner end 4060′ lower than at least the largest diameter of the outer sealed deformation surface 3464′. Herein, the inner diameter is smaller than the smallest diameter of the outer sealed deformation surface 3464′.

The sealing wall 36′ with the second axial abutment 3444′ are arranged relative to the tilted sealing surface 406 and the axial abutment 404′ so that the inner end of the sealing wall 36′ is first in contact with the tilted sealing surface 406 to elastically deform the sealing wall 36′. Then, as can be seen in FIG. 9b, in the abutment position, the sealing wall 36′ is elastically deformed by the tilted sealing surface 406′ of the second tube 4′ yielding stresses in the outer sealed deformation surface 3464′ of the first tube 3 and in the tilted sealing surface 406′ of the second tube providing sealing. It can be seen that the deformation of the sealing wall 36′ generates a deformation of the outer sealed deformation surface 3464′ which is closer to the frustoconical surface of the tilted sealing surface 406 than to its curvature in the initial state (without elastic deformation before being in contact with the tube 4′).

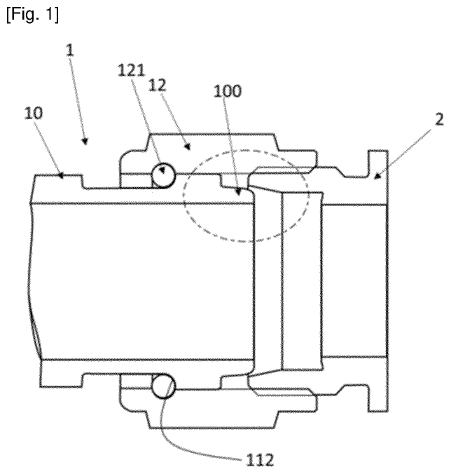

Optionally, the tubular assembly E is marked by a visual indicator according to one aspect of another invention. FIGS. 10 and 11 represent the marking of the joined assembly R according to the first example of the first embodiment but can also be applied to its alternative and to the second example as well as to the second embodiment. The marking can also be applied to the example described in FIG. 1 by modifying it.

The joining wall 342 comprises an outer surface comprising, between the first surface forming a first axial abutment 3440, and an end of the joining wall 342 axially opposite to the sealing wall 36, a visual indicator 307 corresponding to a zone at least partially covered with the fastening member 32 in the free position and at least partially uncovered in the abutment position, when the fastening member is coupled to a second tube 4.

In this example, as can be seen in FIG. 11, the visual indicator 307 is only fully uncovered in the abutment position. In this example, as can be seen in FIG. 10, the visual indicator 307 is partially uncovered from the free position 307. In this example, the fastening member 32 comprises notches 327 located at an axial end opposite to the axial fastening means 324. These notches allow the visual indicator 307 to be partially covered and thus warn the user whether the fastening member 32 is sufficiently screwed onto the second tube 4 so that the axial abutment 404 of the second tube 4 is in axial abutment with the second axial abutment 3444 of the joining wall 342 of the first tube 3.

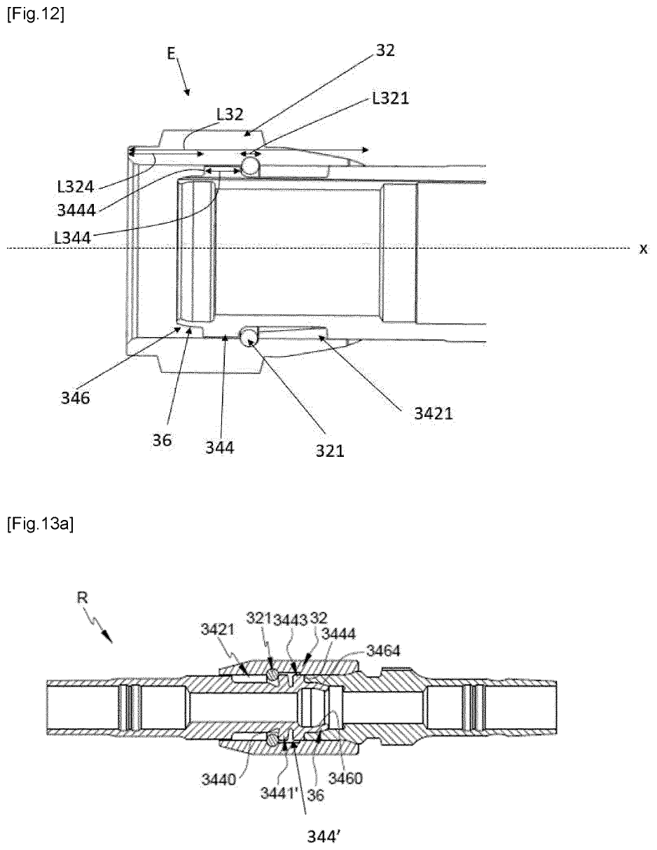

The marking method will now be described in connection with FIG. 12 representing different axial chains of dimensions on an axial cross-section of the first example of the tubular assembly E according to the first embodiment in the abutment position for the marking to operate.

The abutment 321 comprises an axial length l321, the collar 344 comprises an axial length l344, the fastening member 32 comprises a total axial length l32. Assembly E comprises an axial length L324 between the end of fastening member 32 and the second axial abutment 3444 of joining wall 342.

The marking method comprises a step of inserting a second test tube against the second axial abutment 3444 of the first tube 3 forming a joined marking assembly. The second test tube comprising axial fastening means corresponding with that of the fastening member 32, the second test tube is arranged not to elastically deform the sealing wall 36. In other words the second test tube does not comprise a tilted sealing surface 406 but comprises an inner cylindrical wall comprising an inner diameter greater than the maximum outer diameter of the sealing wall 36 of an axial length greater than the axial length of the sealing wall 36, thus enabling the axial end of the second test tube to be in abutment with the second axial abutment 3444. This axial end is preferably a radial surface.

The method then comprises a step of positioning the fastening member 32 in the abutment position by a step of clamping the fastening member 32 to the second test tube to a predetermined torque.

The method then comprises a step of making a visual indicator 307 on the tube 3, herein following the notches 327. This step can be made by laser, for example by marking all around the tube on an axially delimited zone. Herein, the visual indicator is made all around the tube on an axially delimited zone indicating that clamping is not complete. Thus, regardless of the chain of dimensions for lengths L324, L344, L321 and L32, the marking indicates to the user a screwing distance of the fastening member to be made to make sure that there is a minimum pressure between the second axial abutment 3444 of the first tube 3 and the axial abutment 443. Thus, upon manufacturing the assembly E, these chains of dimensions each have a manufacturing tolerance, generating differences between each object. The visual indicator indicates to the user when the second tube is connected to assembly E that the axial abutment 443 of tube 4 is in abutment against the second axial abutment 3444 of the tube 3.

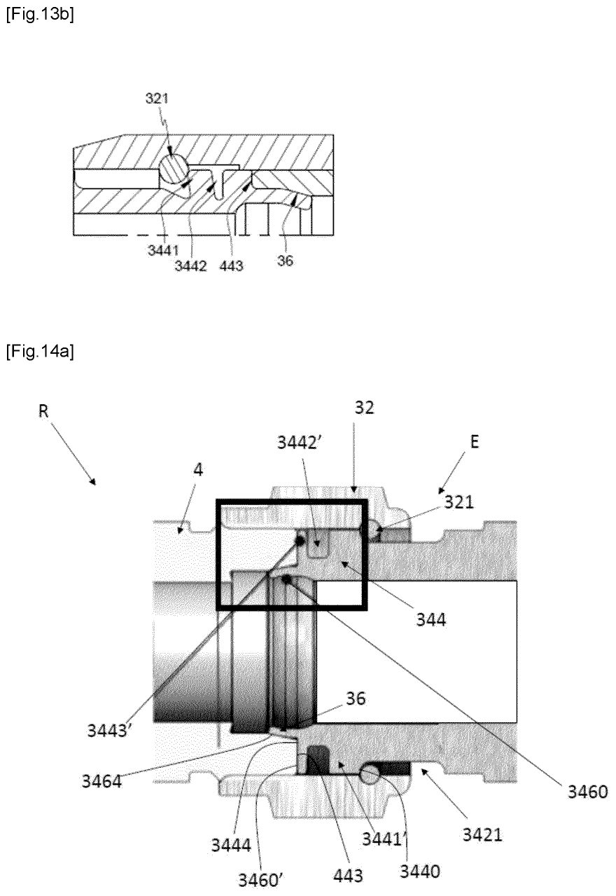

FIG. 13a represents an axial cross-section of an example of part of a joined assembly R comprising a tubular assembly E according to a third embodiment in an abutment position. This tubular assembly E is different from the first example of the first embodiment in that the collar 344′ comprises a groove 3442. The second tube 4 is similar to that of the first example of the first embodiment.

The collar 344′ thus comprises a first portion 3441 comprising the first axial abutment 3440, herein in abutment with the axial abutment 321, herein a snap ring, of the fastening member 32. The collar 344′ comprises, opposite and separated by the groove 3442, a second portion 3443 comprising the second axial abutment 3444, herein in abutment against the axial abutment 404 of the second tube 4. The axially measured thickness of the second portion 3443 is preferably greater than that of the first portion 3441. The axially measured thickness of the first portion is further greater than the thickness of the sealing wall 36 measured between the inner surface 3460 and the outer sealed deformation surface 3464 perpendicular thereto. This thus allows the sealing wall 36 to deform elastically prior to deformation of the snap ring or first portion 3441.

The groove 3442 allows the first portion 3441 to elastically deform in order to avoid crushing and plastically deforming the snap ring during clamping.

Thus this third embodiment comprises a visual indicator made in the same way as the marking method explained above, such that at the step of positioning the fastening member 32 in the abutment position by a step of clamping the fastening member 32 to the second test tube up to a predetermined torque, this further elastically deforms this first portion 3441 in order to ensure proper sealing between the first tube 3 and the second tube 4.

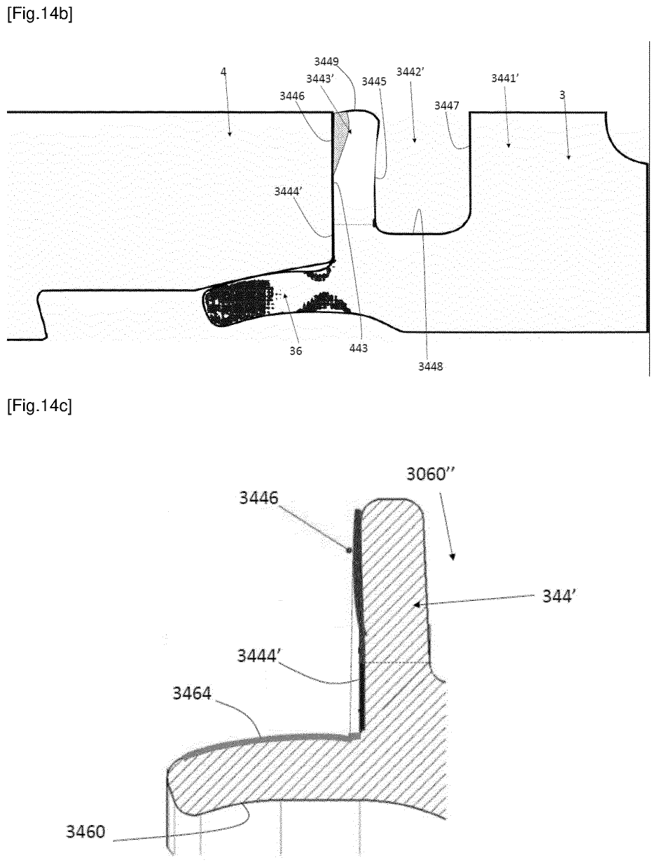

FIG. 14a represents an axial cross-section of an example of part of a joined assembly R comprising a tubular assembly E according to a fourth embodiment in an abutment position. This tubular assembly E is different from the example of the third embodiment in that the second portion is a second sealing and abutment wall 3443′, comprising an outer sealed deformation surface 3446 extending from the second surface 3444 forming the second axial abutment. The groove 3442′ is in this embodiment sufficiently close to the outer sealed deformation surface 3446 for the second sealing and abutment wall 3443′ to deform elastically when in contact with the tube 4. FIG. 14b schematically represents an enlargement of the zone framed by the tube 4 against the tube 3 as well as stresses (schematically) in this second sealing and abutment wall 3443′ as well as in that of the sealing wall 36 of revolution. Thus the axially measured thickness of the second sealing and abutment wall 3443′ is preferably lower than that of the first portion 3441′ (in contrast to the third embodiment). The depth of the groove 3442′ is further such that the end of the second axial abutment 3444 closest to the axis is closer to this axis than the bottom of the groove 3442′. In other words, the radius of the bottom of the groove is greater than the smallest radius of the second axial abutment 3444 (at the fillet with the wall 36).

The second tube 4 is similar to that of the first example of the first embodiment.

The collar 344′ thus comprises a first portion 3441 comprising the first axial abutment 3440, herein in abutment with the axial abutment 321, herein a snap ring, of the fastening member 32. The first portion 3441 comprises, opposite to the first axial abutment 3440, a second surface 3447 visible in FIG. 14b. The collar 344′ comprises, opposite and separated by the groove 3442, the second sealing and abutment wall 3443′ comprising the outer sealed deformation surface 3446 extending from the second axial abutment 3444′ as visible in FIG. 4c and in FIGS. 4a and 4b, in abutment against the axial abutment 443 of the second tube 4 (also referenced in other examples as 404, 404′).

The axially measured thickness of the second sealing and abutment wall 3443′ is furthermore closer to the thickness of the sealing wall 36 measured between the inner surface 3460 and the outer sealed deformation surface 3464, the measurement being taken perpendicular to these two surfaces. The axially measured thickness of the first portion 3441′ is further greater than the thickness of the sealing wall 36 radially measured between the inner surface 3460 and the outer sealed deformation surface 3464 perpendicular thereto. This thus allows the sealing wall 36 and the second sealing and abutment wall 3443′ to deform elastically prior to a deformation of the snap ring or the first portion 3441.

Thus this example of this fourth embodiment comprises a visual indicator made in the same way as the marking method explained above, such that in the step of positioning the fastening member 32 in the abutment position by a step of clamping the fastening member 32 to the second test tube up to a predetermined torque, this further elastically deforms this first portion 3441 in order to ensure proper sealing between the first tube 3 and the second tube 4.

According to one example of this embodiment, the second sealing wall 3443′ of the collar 344′ further comprises a radial inner surface 3445 defining the volume of the groove 3442′ by axially delimiting it with the surface 3447 of the first portion 3441′. This inner radial surface 3445 extends between a first radial end and a second radial end joining a surface of the bottom 3448 of the groove 3442′. The first radial end is opposite to the second radial end. The second sealing wall 3443′ of the collar 344′ comprises a radial outer surface 3449 joining a first radial end of the outer sealed deformation surface 3446 and the first radial end of the radial inner surface 3445.

The second sealing wall 3443′ of the collar 344′ is radially delimited by an inner end represented in dotted line in FIG. 14c, axially extending between the second radial end of the radial inner surface 3445 and a second radial end of the outer sealed deformation surface 3446 joining the second surface forming a second axial abutment 3444′.

According to this example of this embodiment, the outer sealed deformation surface 3446 comprises an extra thickness as is visible in FIG. 14C which surrounds (very slightly as is represented by the dotted lines) part of the sealing wall 346 of revolution.

Unless otherwise specified, a same element appearing in different figures has a single reference.

1. A tubular assembly to be joined to a second tube, the assembly comprising:
a tube of revolution about an axis comprising a connection zone comprising:
a joining wall of revolution comprising at least one collar comprising:
1. a first surface forming a first axial abutment, and
2. a second surface forming a second axial abutment for abutting against the second tube,
a sealing wall of revolution extending from the joining wall, the sealing wall comprising:
3. a tilted part comprising:
a. a first end forming a free edge surrounding an axial opening of the tube,
b. a second end axially opposite to the first end,
c. an outer sealed deformation surface having a diameter progressively and continuously increasing from the first free end to the second end,
4. an inner surface radially opposite to the outer sealed deformation surface, formed by a counterbore for elastically deforming the sealing wall by a compression having at least one axial component on the outer sealed deformation surface,
an fastening member mounted and axially movable about the connection zone between a free position and an abutment position, comprising:
an axial fastening means for being fastened to a complementary fastening means on the second tube to be joined, and
an axial abutment abutting against the first axial abutment of the collar of the tube in the abutment position.

2. The tubular assembly to be joined to a second tube according to claim 1, wherein the joining wall comprises a groove extending from the first surface of the collar to another abutment surface, the axial abutment of the fastening member being movable in the groove between the first axial abutment, and the other abutment surface delimiting the groove.

3. The tubular assembly to be joined to a second tube according to claim 1, wherein the collar comprises a groove dividing the collar into a first and a second part, the first part comprising the first axial abutment comprising an axially measured thickness:
lower than that of the second portion comprising the second axial abutment,
greater than the thickness of the sealing wall measured between the inner surface and the outer sealed deformation surface.

4. The tubular assembly to be joined to a second tube according to claim 1, wherein the sealing wall further comprises a cylindrical part of revolution extending from the tilted part to the second axial abutment of the collar.

5. The tubular assembly to be joined to a second tube according to claim 1, wherein the joining wall comprises an outer surface comprising, between the first surface forming a first axial abutment and one end of the joining wall opposite axially to the sealing wall, a visual indicator corresponding to a zone at least partially covered with the fastening member in the free position and at least partially uncovered in the abutment position, when the fastening member is coupled to a second tube.

6. The tubular assembly to be joined to a second tube according to claim 5, wherein the visual indicator is only fully visible in the abutment position.

7. The tubular assembly to be joined to a second tube according to claim 5, wherein the fastening member comprises an axial end opposite to the axial fastening means, the fastening member comprising notches at this axial end.

8. The tubular assembly to be joined to a second tube according to claim 1, wherein the fastening member is a nut and the fastening means is a tapping to be screwed to a thread of the second tube.

9. The tubular assembly to be joined to a second tube according to claim 1, wherein the outer sealed deformation surface is curved.

10. The tubular assembly to be joined to a second tube according to claim 1, wherein the part of the inner surface forming part of the tilted part of the sealing wall is curved.

11. The tubular assembly to be joined to a second tube according to claim 1, wherein the outer sealed deformation surface is tilted relative to an axis of the tube at a mean angle of between 1° and 45° inclusive.

12. The tubular assembly to be joined to a second tube according to claim 1, wherein the outer sealed deformation surface is tilted relative to an axis of the tube at a mean angle of between 45° and 90°, the counterbore forming a recess delimiting the sealing wall forming its inner surface.

13. A joined assembly comprising:
an assembly according to claim 1,
the second tube comprising:
a sealing surface tilted relative to the axis in contact and bearing against the outer sealed deformation surface elastically deforming the sealing wall and
an axial abutment axially abutting with the second axial abutment of the joining wall and wherein the axial fastening means is fastened to the complementary fastening means,
a lubricant layer between the outer sealed deformation surface and the tilted sealing surface.

14. A method for marking a tubular assembly according to claim 1, comprising:
a step of inserting a second test tube against the second axial abutment forming a joined marking assembly, the second test tube comprising axial fastening means corresponding with that of the fastening member, the second test tube being arranged not to elastically deform the sealing wall,
a step of positioning the fastening member in the abutment position, by a step of clamping the fastening member to the second test tube up to a predetermined torque,
a step of making a visual indicator on the tube.
